(19) United States
(12) Patent Application Publication
(10) Pub. No.: US 2010/0100433 A1
(43) Pub. Date: Apr. 22, 2010

(54) Method and System for Promoting Artistic Works

(76) Inventor: Michael Penfield, Darien, CT (US)

Correspondence Address: CHRISTINE JOHNSON ESQ., 151 Trenton Rd., Fairless Hills, PA, 19030, US

(21) Appl. No.: 12/528,380

(22) PCT Filed: Mar. 5, 2008
(86) PCT No.: PCT/US08/55961

§ 371 Date: Aug. 24, 2009

Related U.S. Application Data
(60) Provisional application No. 60/904,972, filed on Mar. 5, 2007.

(51) Int. Cl. G06Q 30/00; G06F 3/048; G06Q 20/00; G06Q 50/00

(52) U.S. Cl. 705/14.16; 715/760; 705/27

(57) ABSTRACT

The invention provides new and improved methods and systems for online promotion, marketing and distribution of artistic works. An embodiment of a system for distributing artistic works comprises an online store configured for sale and distribution of artistic works to individual buyers. A link server is configured to store links to webpages related to artists works stored in the online store. The link server is configured to download at least one link to a fan computer via the Internet in response to a fan-initiated request for at least one link. The links are configured for embedding by said fan in a clickable portion of the fan's webpage. The online store tracks purchases of artistic works corresponding to a fan's link. The online store provides a reward to the fan based on the tracked purchases.

### CROSS REFERENCE TO RELATED APPLICATIONS

This application claims benefit of priority to U.S. provisional patent application Ser. No. 60/904,972 filed on Mar. 5, 2007 to inventor Michael Penfield.

### FIELD OF THE INVENTION

The present invention relates generally to methods and systems for marketing and distribution of artistic works.

### BACKGROUND OF THE INVENTION

The record industry is undergoing tremendous change thanks in large part to advances in technology. Using the latest technology, independent artists are capable of producing material of a quality rivaling that of large studios. Widespread use of the Internet exposes the work of independent artists to larger audiences than was possible in the past. As a result fans exert more influence than ever in determining which artists and artistic works will become commercially successful. One way fans can exert influence is by directing the attention of other internet users to an artist or an artistic work. A fan can do this, for example, through the fans' own websites and blogs (e.g. MySpace™ and Facebook™ pages and the like). Visitors to the fan's website may read a fan's comments about an artist or an artist's work. By promoting an artist or an artistic work on a Fan website, a fan can be a significant contributing factor in determining commercial success of an independent artist or an artist's work.

While fans can influence buying decisions of their peers fans do not typically participate directly in formal marketing and distribution processes on behalf of artists. Direct participation in these functions is conventionally limited to producers, promotional agencies, advertising agencies, radio stations and other conventional marketing and distribution means. Unfortunately, many worthy artists lack the necessary resources to access these traditional distribution channels. At the same time fans lack access to conventional means for promoting and distributing the works of their favorite artists.

The present inventor has recognized the need for methods and systems that allow artists and fans to cooperate in a mutually beneficial way to promote and distribute an artist's work.

### SUMMARY OF THE INVENTION

The invention provides methods and systems for online marketing and distribution of media.

### DESCRIPTION OF THE DRAWING FIGURES

These and other objects, features and advantages of the invention will be apparent from a consideration of the following Detailed Description Of The Invention considered in conjunction with the drawing Figures, in which:

FIG. 1 is a pictorial diagram of a marketing and distribution system according to an embodiment of the invention.

FIG. 2 is a flowchart depicting steps of a method of marketing and distributing artistic works according to an embodiment of the invention.

FIG. 3 is a functional block diagram of a marketing and distribution system according to an embodiment of the invention.

FIG. 4 depicts a graphical user interface enabling an artist to provide artist information to a marketing and distribution system according to an embodiment of the invention.

FIG. 5 depicts an example of a graphical user interface enabling a fan to provide fan information to a marketing and distribution system according to an embodiment of the invention.

FIG. 6 illustrates a graphical user interface by which a marketing and distribution system of an embodiment of the invention provides a list of artists and enables a fan to select an artist from the list.

FIG. 7 illustrates an example of a fan signature and an artist product page provided by a marketing and distribution system according to an embodiment of the invention.

FIG. 8 depicts an example of code for a fan signature as provided by a marketing and distribution system according to an embodiment of the invention.

FIG. 9 depicts an example of code for a fan signature after a fan has selected artists to represent as provided by a marketing and distribution system according to an embodiment of the invention.

FIG. 10 is a flowchart illustrating steps of a method for marketing and distributing artistic works according to an embodiment of the invention.

FIG. 11 is a flowchart illustrating steps of a method for marketing and distributing artistic works according to an embodiment of the invention.

FIG. 12 is a flowchart illustrating steps of a method for marketing and distributing artistic works according to an embodiment of the invention.

### DETAILED DESCRIPTION OF THE INVENTION

In accordance with the present invention, there are provided herein methods and systems for online promotion, marketing and distribution of artistic works. As used herein the term “fan” refers to an individual participating in the promotion of at least one artist or at least one creative work of an artist via the Internet. The term “buyer” refers to a potential and/or actual online purchaser of at least one artistic work of an artist. The term “artist” refers to an originator of at least one artistic work. The term “artistic work” refers to a creative work of art made by an artist. An artistic work may be embodied in any media or format, including downloadable files, CDs, DVDs, Video-Cassettes, Film, etc. Artistic works include, but are not limited to audio, motion and still video, photographic, graphic and other types of video and audio artistic works.

### System, Example 1

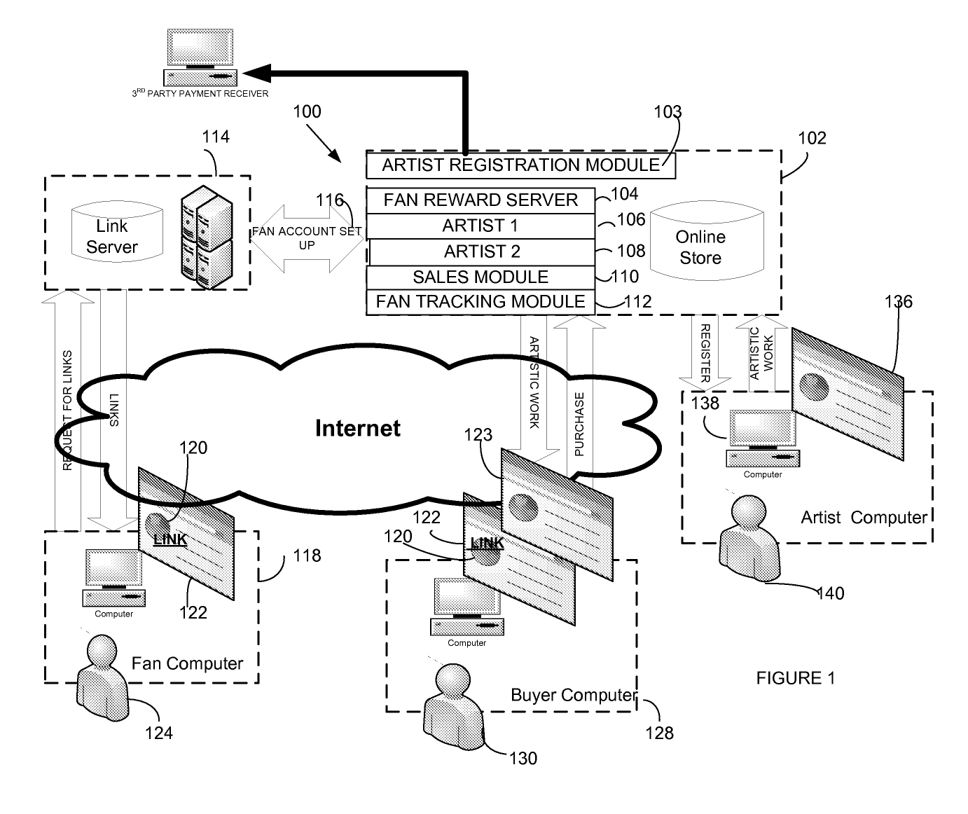

FIG. 1 illustrates a system 100 according to an embodiment of the invention. FIG. 1 illustrates a marketing and distribution system 100 according to an embodiment of the invention. System 100 comprises a link server 114 and an online store 102. Link server 114 is configured to store at least one embeddable, downloadable computer code comprising a link. As used herein the term “link” refers to computer executable code which, when executed, connects a buyer computer 130 to online store 102. In one embodiment of the invention a web page 123 is provided by the online store 102 and displayed to a buyer 130 on the buyer's computer 128. The term link is also used to refer to a graphic representation 120, or icon, displayed on a portion of a fan web page or website 122. In one embodiment of the invention, when a buyer 130 clicks the icon 120, the code for a corresponding link executes, thereby connecting the buyer to the online store 102.

Link server 114 is configured to provide at least one link to a fan 124 for downloading by the fan 124 in response to a request by a fan for the link. Fan 124 makes a request by means of fan computer 118. In that manner Link server 114 cooperates with on-line store 102 through links provided by link server 114 to fan computer 118. In one embodiment of the invention links provided by link server 114 include information corresponding to a work or works of at least one artist 140. In one embodiment of the invention each downloadable link corresponds to an artist 140. In one embodiment of the invention each downloadable link corresponds to an artistic work of an artist 140.

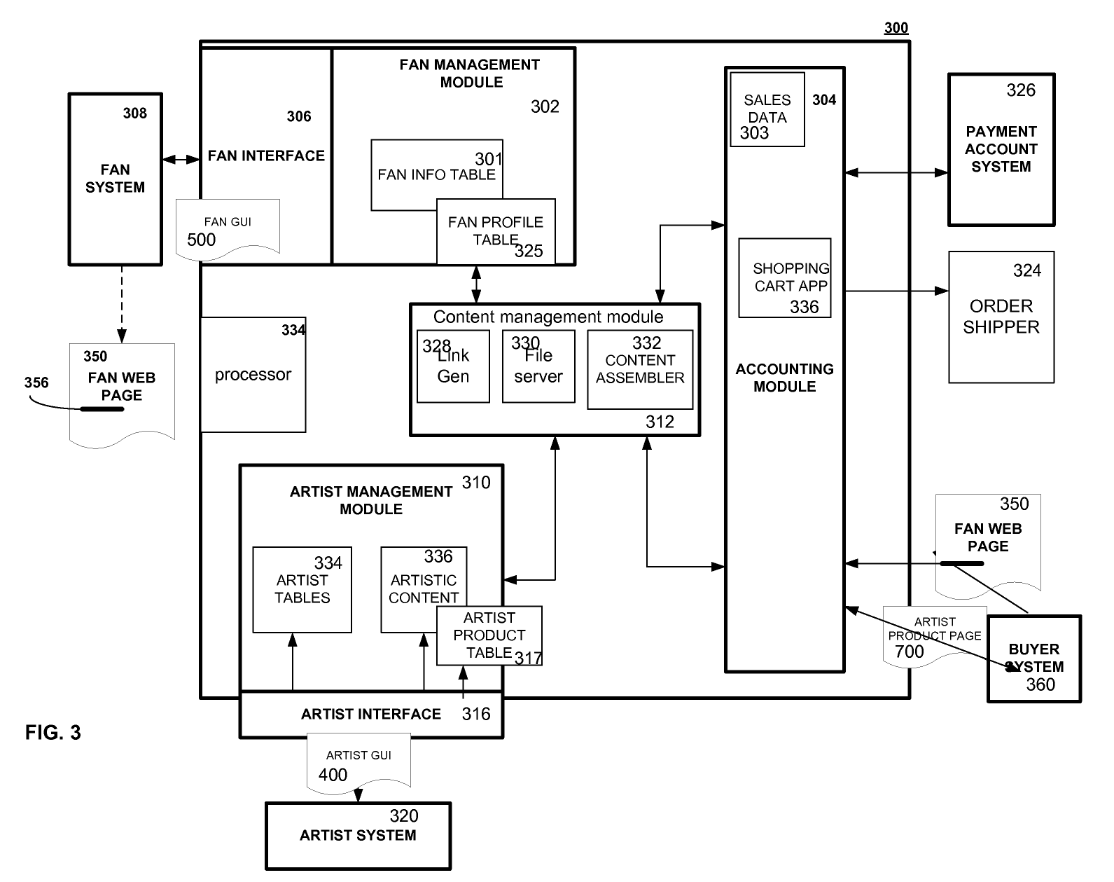

Various embodiments of link server 114 provide links configured for embedding in at least one of: a fan's web pages, fan's blogs, fan's email, or any other distribution means by which a fan may communicate a link. In one embodiment providing links embeddable in web pages, link server 114 enables fans to create html emails that feature fan selected banners for use in fan initiated email campaigns. Link server 114 is illustrated in another embodiment of the invention as link generator 328 of FIG. 3.

Online store 102 of system 100 is configured to provide an online store web page 123 to a buyer 130 when buyer 130 activates (for example by clicking an icon 120 displayed in a fan web page 122) a link to online store 102. In one embodiment of the invention online store web page 123 is configured to allow buyer 130 to purchase a work of an artist 140. According to embodiments of the invention online store 102 accepts an online payment from buyer 130. In some embodiments of the invention online store 102 provides a work to a buyer 130 by downloading a file comprising the work from online store 102 to buyer computer 128. According to embodiments of the invention online store 102 provides a work to a buyer 130 by shipping the work in a suitable media format and package to buyer 130 by conventional shipping means.

According to one embodiment of the invention online store 102 comprises a sales module 110, a fan tracking module 112, artist works modules, e.g., 106, 108, an artist registration module 103 and a fan reward server 104. While two artist work modules are illustrated in FIG. 1, it will be readily appreciated that more than two artist work modules are possible in various embodiments of the invention. Online store 103 is configurable to comprise any number of artists and artist's works and modules corresponding thereto.

In one embodiment of the invention online store 102 is configured to communicate with an artist computer 138 via an artist registration module 103. Online store 102 provides a web page 136 by which an artist 140 registers to enable fan promotion of the artist's work. In one embodiment of the invention online store 102 receives and stores the artist's work in online store 102.

When a buyer 130 views a fan webpage 122 and initiates link 120, the link establishes communication between the buyer 130 and online store 102. In one embodiment of the invention, online store 120 displays an interactive webpage 123 to the buyer. Interactive webpage 123 enables buyer 130 to purchase an artistic work from online store 102. Online store 102 tracks purchases of buyers as they correspond to a link, or links, provided by a Fan 124. In one embodiment of the invention, online store 102 provides a reward to Fan 124 based upon the tracked purchases. In one embodiment of the invention, the reward is based on a dollar or other currency amount related to the sale price of an artistic work, for example, a percentage of a sale, or total sales for a fan. In this way fans can be encouraged to display links and promote sales of artistic works through a financial interest in the success of the product. In different embodiments rewards may take different forms, for example and without limitation: discounted or free artistic works, credits towards live performance events of an artist, and others as will now be apparent to the reader.

### Method Example 1

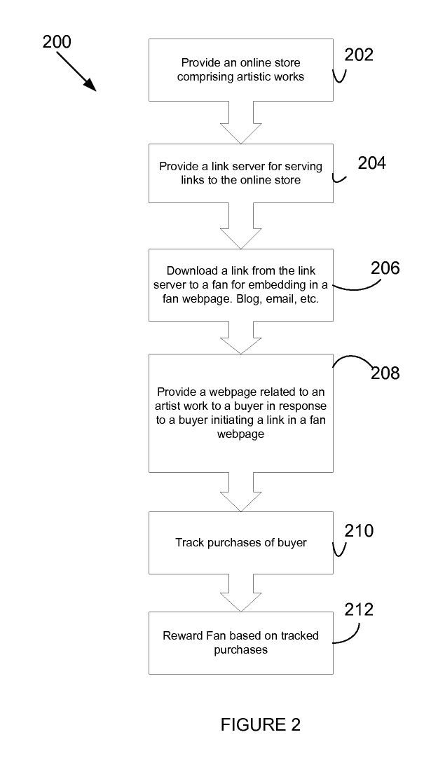

FIG. 2 illustrates a method 200 according to an embodiment of the invention. At step 202 an online store is provided. In one embodiment of the invention step 202 includes steps of storing artistic works in the online store and providing means for buying the stored artistic works. In one embodiment of the invention the means for buying includes a means, for example, an interactive web page, for viewing, reviewing or listening to a stored artistic work. An example of an online store suitable for implementing this step is illustrated in FIG. 1 and described above with respect to system 100.

At step 204 a link server is provided. In one embodiment of the invention step 204 includes a step of storing links to respective artistic works stored in step 202. At step 206 at least one link corresponding to an artistic work is provided to a fan in response to a request for the link by the fan. The fan makes the downloaded link accessible to a buyer, for example, by embedding the link into a webpage of the fan.

Step 208 provides a webpage, for example the interactive web page described in step 202, to a buyer in response to a buyer initiating the link embedded in the fan's webpage. The interactive webpage enables the buyer to purchase an artistic work. In step 210 buyers' purchases corresponding to links in fans' web pages are tracked. In step 212 a reward is provided to a fan based on tracked purchases corresponding to a link in the fan's webpage.

One embodiment of the invention comprises an online store configured for sale and distribution of artistic works to individual buyers. A link server is configured to store links to web pages related to artists works stored in the online store. The link server is configured to download at least one link to a fan computer via the Internet in response to a fan initiated request for at least one link. The links are configured for embedding by said fan in a clickable portion of the fan's webpage. In one embodiment, sales of artistic works arising from a fan's link are tracked and a reward provided to the fan based on the tracked sales.

### System, Example 2

### FIG. 3

FIG. 3 illustrates a system 300 for promoting artistic works according to an embodiment of the invention. System 300 comprises an artist management module 310, a fan management module 302, an accounting module 304 and a content management module 312. A processor 334 is programmed in accordance with the specification provided herein to implement the various functions and features of the invention provided by the modules comprising system 300.

Content management module 312 is coupled to artist management module 310, fan management module 302 and accounting module 304. Content management module 312 is configured to receive data and other content from fan systems 308, artist systems 320 and third party payment systems 326. Content management module 312 receives the data and other content via the various graphical user interfaces described herein and stores the data and content in corresponding tables, also described herein. Content management module 312 is further configured to retrieve the stored content and data to provide further graphical user interfaces and to display information to viewers to carry out the various embodiments of the invention described herein.

In one embodiment of the invention content management module 312 is implemented using Joomla! Joomla! is a readily available open source content management system for publishing content on the world wide web and intranets. In one embodiment of the invention content management module 312 is coupled to at least one MYSQL database for storage and retrieval of information, data, media and other content received via fan interface 306, artist interface 316 buyer system 360 and payment account system 326 to implement the various embodiments of the invention. The invention is described herein in conjunction with various tables comprising data grouped by functional relationship. However, table names and functionally associated table content are provided for ease of discussion. As those of ordinary skill in the art will readily appreciate upon reading this specification, a wide variety of table configurations and data arrangements are possible to implement the functions and features of the invention. All of these are intended to remain within the scope of the invention described herein.

In one embodiment of the invention system 300 is implemented on a Linux compatible computer system configured for deployment of an Apache server application. Other embodiments of the invention are suitable for implementation on Windows based computers and other commonly available computer systems.

### Artist Management Module

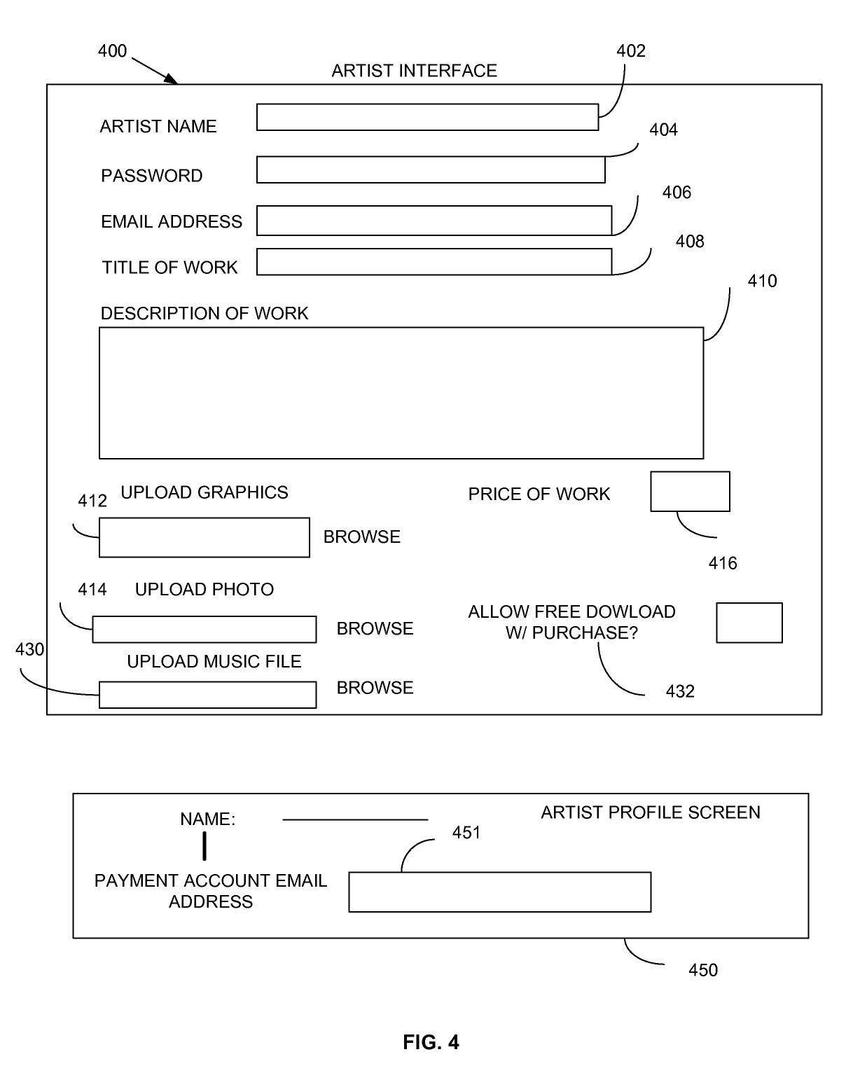

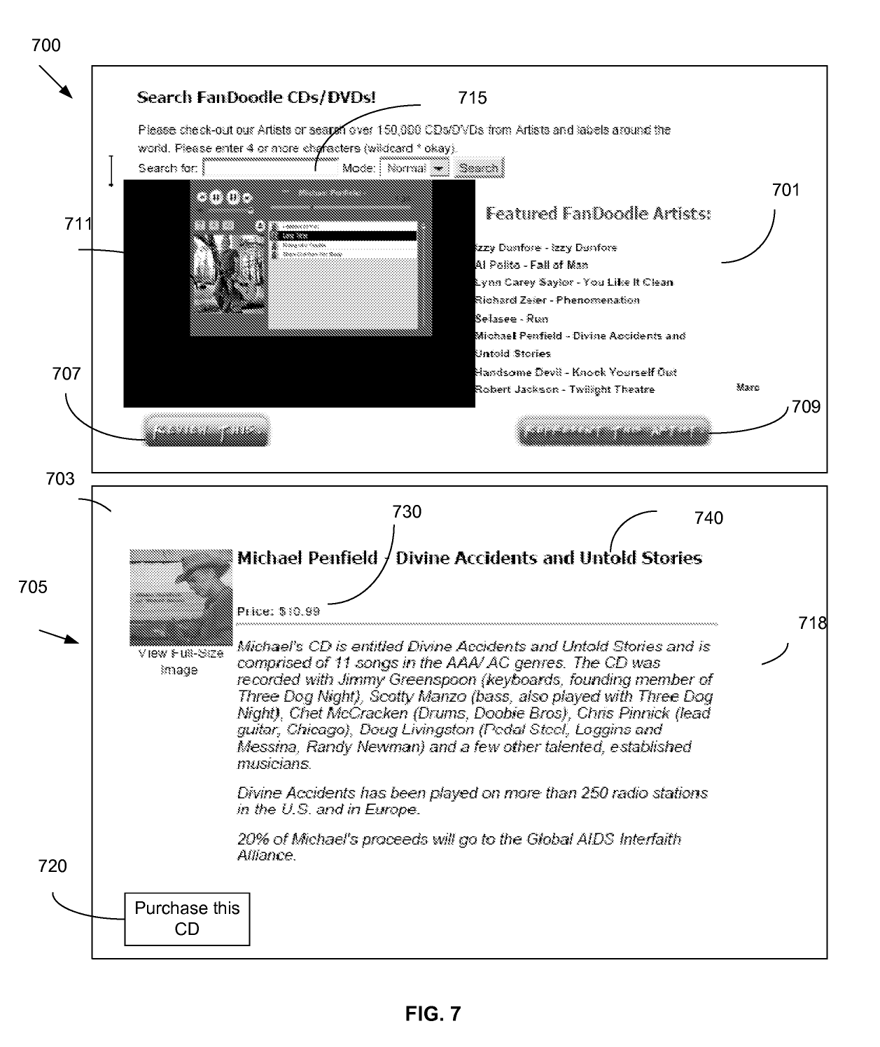

Artist management module 310 includes an artist interface unit 316. Artist interface unit 316 provides graphical user interfaces (GUI), for example GUI 400 of FIG. 4. GUIs enable an artist system 320 to interact with promotion and distribution system 300. For example, an artist (or record label or owner of a work of music or film art) can log-on to system 300 and create content for an artist product page (example illustrated in FIG. 7 at 705) using a GUI such as GUI 400. As explained in more detail below, an artist product page 705 displays information about an artist and the artist's work e.g. biography, discography, track listing, etc. The artist product page 705 further includes a link 720 enabling a page viewer to interact with accounting module 304 to purchase the artist's work.

It will be noted that only one artist system 320 is illustrated in FIG. 3. This illustration is for ease of discussion. However, it will be readily appreciated upon reading this specification that the number of artist systems 320 communicating with system 300 is not limited. In embodiments of the invention wherein communication between artist system 320 and system 300 is established via the World Wide Web, the number of artist systems communicating with system 300 at any given time is virtually unlimited.

An example graphical user interface (GUI) 400 comprising artist interface 316 is illustrated in FIG. 4 at 400. GUI 400 is displayed on a display screen of artist system 320. An interactive portion 402 of GUI 400 receives the name of the artist as entered by the artist using artist system 320. Similarly an artist's email address is provided at 406, a title for a work, for example a CD title is provided at 408, and description of the artist's work is provided at 410. In other embodiments of the invention, more or less information may be provided by an artist using GUI 400.

In one embodiment of the invention GUI 400 further includes an interactive area 412 enabling system 300 to communicate with system 320 to upload graphics representing the artist's work, for example, a graphic illustration of a CD or DVD cover. In other embodiments of the invention GUI 400 provides an interactive area 414 enabling system 300 to communicate with artist system 320 to upload photos from artist system 320.

In one embodiment of the invention GUI 400 is generated by content management module 312 as a form. Content management module 312 collects the artist data described above via the form and provides the collected data to tables 334 and 336 of artist management module 310. In one embodiment of the invention tables 334 and 336 are implemented using a MySQL database. Other embodiments of the invention may employ other commercially available and customized databases to implement the various tables described in this specification.

Data and content provided by an artist is stored in tables 334 and 336 in association with the artist's system assigned artist id. Each time an artist logs-on to system 300, at least a portion of the stored content associated with that artist is made available to that artist for viewing editing and saving via a graphical user interface such as GUI 400. An example of an artist information table implemented in a MySQL database suitable for use in the invention is provided in Table I.

TABLE I
ARTIST INFORMATION TABLE

| | | | | | | | | | | |
|---|---|---|---|---|---|---|---|---|---|---|
| ARTIST | ARTIST | | PROD | PROD | | | PREVIEW | COVER | | |
| NAME | PW | EMAIL | TITLE | DESC | PRICE | TRACKS | TRACK | GRAPHICS | IMAGE | DLD |

### Artist Product Page

Content management module 312 cooperates with artist management module 310 to collect and store information, graphics, content, photos and other items provided via GUI 400 for use in generating artist product pages for promoting the artist and the artist's work. Based on the information received via the artist GUI 400, content assembler 332 of content management module 312 generates an artist product page for each product of each artist.

An example of an artist product page is illustrated in FIG. 7 at 705. As illustrated in FIG. 7 an image 703 representing the artist's work, for example, an image of a CD cover is displayed in a portion of a display screen 703. A title 740 of the artist's work is displayed in a separate portion of the display screen 703. Likewise a description of the work 718 and a purchase price 730 are displayed on the artist's product page in a portion of display screen 703. A product page 705 further includes a link 720 enabling purchase of the product identified in the product page.

In one embodiment of the invention, the information received via GUI 400 used in generating an artist product page is stored in an artist product page table. In one embodiment of the invention artist product page tables are implemented using a MySQL database. Each time an artist submits a work to be promoted, accounting module 304 of system 300 generates a unique product identifier, for example, a product number, for the work. The product number is stored in artist product table 317 of artist management module 310. This data table is updatable to allow an artist edit the data. An example of an artist product table is given in Table II. If the data being submitted represents a new artistic work, the work is assigned a unique, sequential Product Number. The product number is stored in the artist product table. This data table is updatable to add new products for an artist.

In some embodiments of the invention an artist product page is displayed together with an artist selection page portion, for example portion 700 illustrated in FIG. 7. Artist selection page portion 700 includes a listing of artists 701. In one embodiment of the invention an mp3 player 711 with sample tracks from a selected artist is embedded in the artist selection page portion 700. Screen portion 700 further provides a link 709 for generating unique code identifying the product described in the corresponding product page 705. Activation of the link 709 causes code to be generated by link generator 328 and displayed in a text box of a screen displayed to a fan.

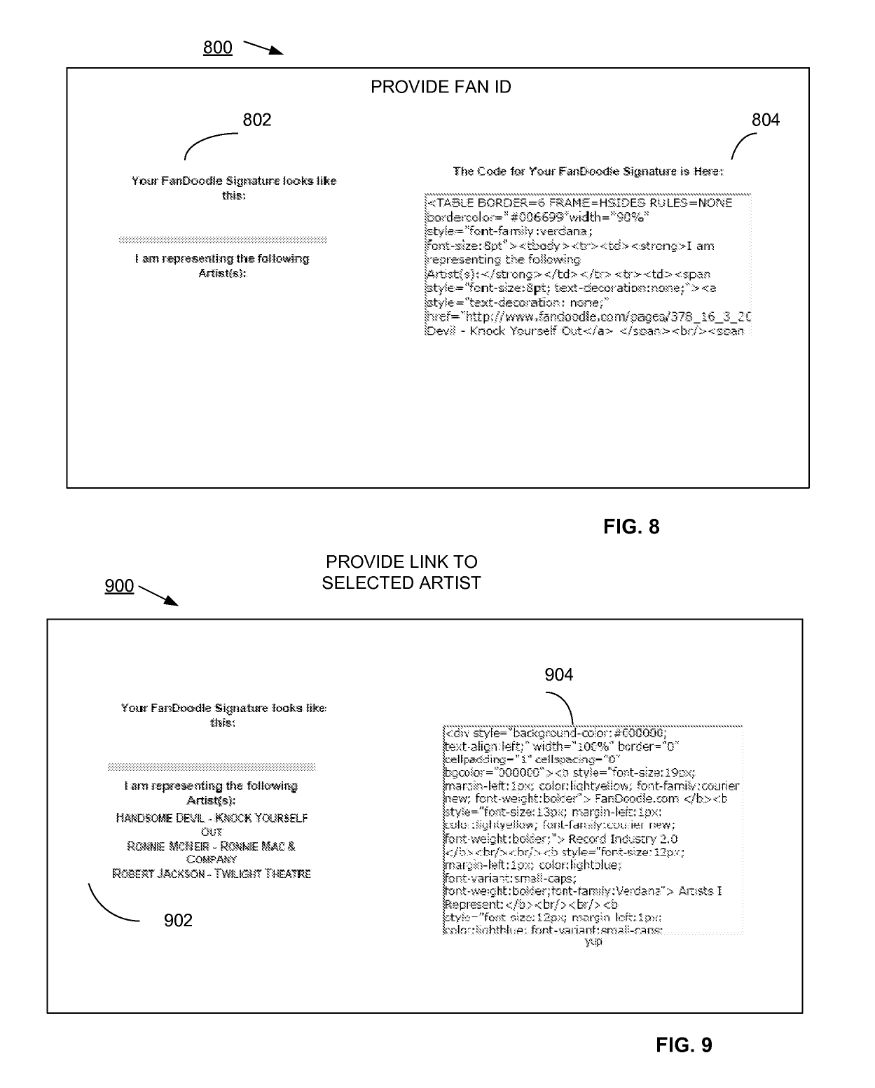

FIG. 8 illustrates a screen 800 displayed to a fan including a text box 804 displaying code generated by code generator 328. Using the displayed code, a fan is provided with a unique affiliate marketing code that creates a text link to the product page 705 when the code is embedded in the fan's website, email or other electronic communication. Any time a product page 705 for an artist is served to a fan, the fan id number of the logged-on fan is generated by link generator 328 along with the product number associated with the product page 705. This allows unique code, including the product number and the fan id number to be generated for a fan to copy/paste and begin representing their selected artist(s).

TABLE II
Artist Product Page Table

| | | | | | | | | |
|---|---|---|---|---|---|---|---|---|
| | | Product | | | Product | | | |
| Product | Vendor | parent | Product | Product | thumb | | | Full |
| id | id | id | SKU | description | image | URL | Artist_id | Image |

### Fan Management Module

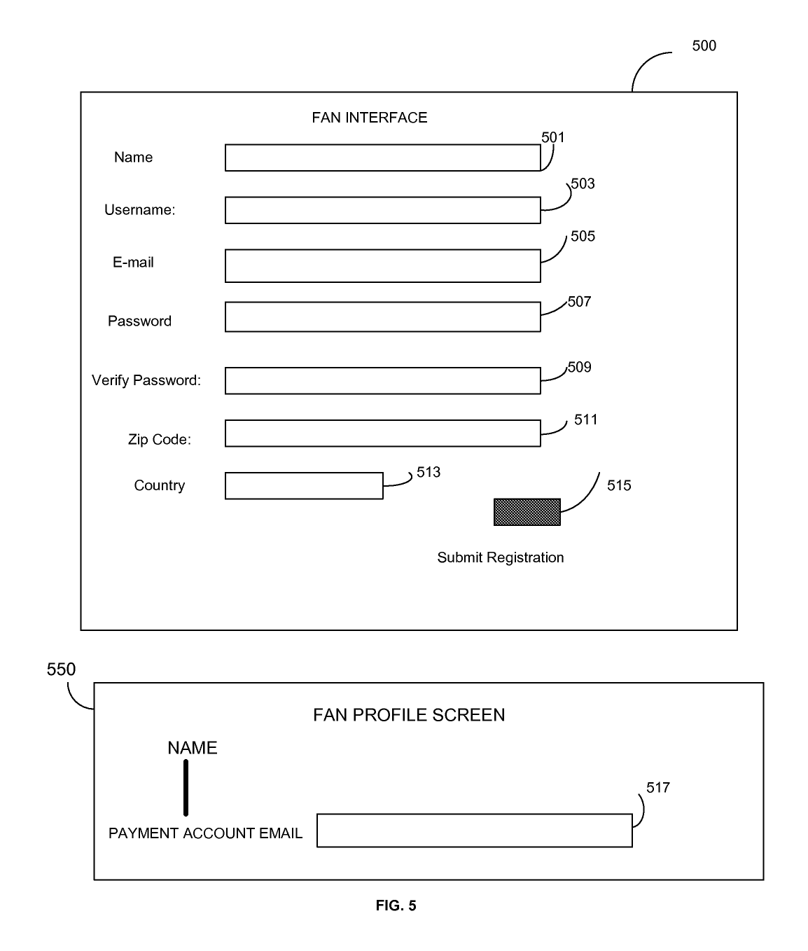

Fan interface unit 306 comprises graphical user interfaces (GUI), for example GUI 500 of FIG. 5. GUI 500 enables a fan system 308 to interact with promotion and distribution system 300. Only one fan system 308 is illustrated in FIG. 3 for ease of discussion. However, it will be readily appreciated upon reading this specification that the number of fan systems communicating with system 300 is not limited. In embodiments of the invention wherein communication between fan system 308 and system 300 is established via the World Wide Web, a number of fan systems communicating with system 300 at any given time is virtually unlimited.

In operation a fan utilizes a fan computer system 308 to interact with fan management module 302 of system 300. In one embodiment of the invention a communication link is established between fan computer system 308 and system 300 via the Internet. In one embodiment of the invention a fan GUI 500 is structured as a form that collects fan data and provides the data to a table implemented using a MySQL database where the data is stored as fan information. As illustrated in FIG. 5 system 300 receives information about the fan when the fan enters information into fields 501-515 of GUI 500.

In response to a fan providing information to system 300 and selecting the “submit” icon 515 of GUI 500, system 300 generates a unique fan id for the fan. The fan id uniquely identifies the fan to system 300. The data collected by GUI 500 is associated with the fan id and stored by system 300 for later retrieval. In one embodiment of the invention fan information received via GUI 500 is stored in fan table 301 of fan management module 302.

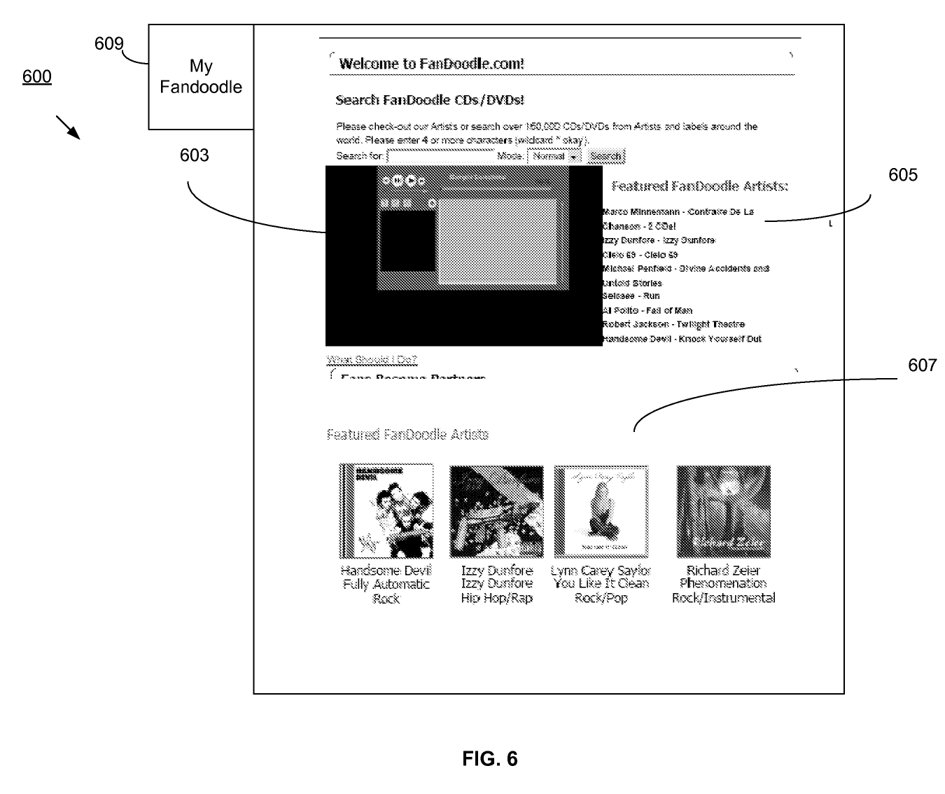

After initially logging in to system 300 a fan is provided with a GUI 600 comprising information about artists. An example of a suitable GUI for presenting information about artists to a fan is illustrated in FIG. 6. By selecting an artist from list 605, or by selecting an icon from list 607, a fan is enabled to access artist product pages 705, listen to samples of artist works and select artists to represent.

GUI 600 further comprises a selectable link 609 to a page displaying the fan's profile as illustrated in FIG. 8 at 800. A fan profile page comprises information associated with an individual fan and the artists the fan has selected to represent. For example, a fan profile page 800 displays a fan signature 802. A fan signature 802 is an icon, or other graphic or text representation identifying the fan and indicating artistic works the fan has selected to represent. As the fan selects artistic works to represent, for example by using interactive icon 709 of GUI 700, the fan's signature 802 is updated to display an indication of the selected artistic works. In one embodiment of the invention illustrated in FIG. 9, the indications of selected artist works comprise corresponding links 902 to corresponding artist product pages 705 as described above with respect to FIG. 7.

Along with the fan signature a portion 802 of the displayed page 800 displays code 804 for generating the fan's signature. The code 804 is available for the fan to copy and paste. Using a copy and paste function the fan can insert the code into the fan's own web pages, myspace pages, facebook pages, emails, web sites and other electronic communication used by the fan, thereby reproducing the fan signature including the selected artists and the fan id. When the link is activated by a viewer, the code executes to display an artist product page to the viewer. As described above the artist product page includes appropriate links to purchase module 304 of system 300 to enable the viewer to review and purchase the artist's work. In that manner, the fan represents the artist by making the artist's product information and product available for purchase to viewers of the fan's media.

A fan is provided with a list of artists available to be represented by the fan. FIG. 6 illustrates a graphical user interface 600 for enabling a fan to view and select artists to be represented. The GUI includes a selectable icon enabling the fan to select an artist to represent.

In one embodiment of the invention, the information about selected artists received via GUI 500 is stored in a fan profile table 325 implemented in MySQL database. Table 1I is an example of a fan table suitable for use in embodiments of the invention.

TABLE II
FAN PROFILE TABLE

| | Fan | |
|---|---|---|
| Fan name | id | Profile |
| Jane Doe | 248 | <TABLE BORDER=6 FRAME=HSIDES RULES=NONE |
| | | bordercolor=“#006699”width=“90%” style=“font-family:verdana; font- |
| | | size:8pt”><tbody><tr><td><strong>I am representing the following |
| | | Artist(s):</strong></td></tr><tr><td><span style=“font-size:8pt; text- |
| | | decoration:none;”><a style=“text-decoration: none;” |
| | | href=“http://www.fandoodle.com/pages/248_16_3_20.htm”target=\“_parent\”>Handsome |
| | | Devil - Knock Yourself Out</a> </span><br/><span style=“font-size:8pt; |
| | | text-decoration:none;”><a style=“text-decoration: none;” |
| | | href=“http://www.fandoodle.com/pages/378_21_3_26.htm”target=\“_parent\”>Ronnie |
| | | McNeir - Ronnie Mac & Company</a> </span><br/><span style=“font- |
| | | size:8pt; text-decoration:none;”><a style=“text-decoration: none,” |
| | | href=“http://www.fandoodle.com/pages/378_10_3_24.htm”target=\“_parent\”>Robert |
| | | Jackson - Twilight Theatre</a> |
| | | </span><br/></td></tr><tr><td><br/><strong>These are some of my favorite |
| | | CDs/DVDs/records:</strong><br/></td></tr><tr><td><i>FanDoodle.com - Fans |
| | | become Partners<i></td></tr></span></table> |
| John Doe | 249 | <TABLE BORDER=6 FRAME=HSIDES RULES=NONE |
| | | bordercolor=“#006699”width=“90%” style=“font-family:verdana; font- |
| | | size:8pt”><tbody><tr><td><strong>I am representing the following |
| | | Artist(s):</strong></td></tr><tr><td><span style=“font-size:8pt; text- |
| | | decoration:none;”><a style=“text-decoration: none;” |
| | | href=“http://www.fandoodle.com/pages/249_16_3_20.htm”target=\“_parent\”>Handsome |
| | | Devil - Knock Yourself Out</a></span><br/><span style=“font-size:8pt; |
| | | text-decoration:none;”><a style=“text-decoration: none;” |
| | | href=“http://www.fandoodle.com/pages/378_21_3_26.htm”target=\“_parent\”>Ronnie |
| | | McNeir - Ronnie Mac & Company</a></span><br/><span style=“font- |
| | | size:8pt; text-decoration:none;”><a style=“text-decoration: none;” |
| | | href=“http://www.fandoodle.com/pages/378_10_3_24.htm”target=\“_parent\”>Robert |
| | | Jackson - Twilight Theatre</a> |
| | | </span><br/></td></tr><tr><td><br/><strong>These are some of my favorite |
| | | CDs/DVDs/records:</strong><br/></td></tr><tr><td><i>FanDoodle.com - Fans |
| | | become Partners<i></td></tr></span></table> |

### Content Management Module 312

Content Management Module 312 organizes and manages artistic works, artist information, links, fan and artist tables, graphics, video and other content gathered by the fan and artist graphical user interfaces comprising system 300. For example, content management module 312 is configured to populate a fan graphical user interface with a current list of artistic works from artist tables 334. When a fan selects an artistic work from the list of works, content management module 312 is configured to generate appropriate links for artist product page corresponding to the work via link generator 328. The links for selected artistic works are provided to the fan via the fan graphical user interface.

### Accounting Module

In one embodiment of the invention accounting module 304 is implemented using commercially available affiliate tracking software such as iDevAffiliate™. In addition accounting module 304 includes a conventional shopping cart application as indicated in FIG. 3 at 336.

Accounting module 304 is configured to automatically create an account and an associated user_id for each artist and fan registering with system 300 via artist system 320 or fan system 308. After initial registration by a fan or an artist, the fan or artist can access his or her profile update page. A profile update page allows the fan or artist to update information such as address and other contact information, change text and perform other housekeeping tasks. Accounting module 304 of system 300 provides an interactive field on the update page to allow the fan or artist to provide payment account information. FIG. 4 illustrates an example of an interactive update page 450 including an account field 451 for providing a payment account email address. In addition, interactive update page 450 displays at least some of the information displayed on artist interface GUI 400. In that manner an artist is enabled to change at least some of the information provided upon initial registration.

FIG. 5 illustrates an example of an interactive update page 550 for a fan profile including an account field 517 for providing a payment account email address. In addition, interactive update page 550 displays at least some of the information displayed on fan interface GUI 500. In that manner a fan is enabled to change at least some of the information provided during initial registration.

Accounting module 304 uses the account email address provided as described above to track links to product pages and to associate product page links with links provided to fans for embedding in fan's web pages, etc. Accounting module 304 also uses the account information to initiate payment to fans and artists when a product is purchased. Accounting module 304 collects and stores data related to product purchases in a Purchase Tracking Table. An example of a purchase tracking table is provided in Table IV.

TABLE IV
Purchase Tracking Table

| username | fanid | category | prod_id | artist_id | prod_name | userid | prod_desc |
|---|---|---|---|---|---|---|---|
| jandoe | 100 | 2 | 28 | 21 | Jane Artist- | 71 | Rock, Pop |
| | | | | | Best of | | |
| | | | | | Artist CD | | |

### Link Generator

Link generator 328 of content management module 312 uses the user_id provided by accounting module 304 to generate links including identification of artist works and fans. For example, link generator 328 generates code as illustrated in FIG. 8 at 804 and FIG. 9 at 904.

### Table III Inventory Table

Accounting module 304 receives information provided by artists using GUI 400 to build a product table as illustrated in Table III below. When an artist enters a new artistic work for distribution accounting module 304 assigns a product id. A product description is generated based on the description provided by the artist. In addition, various embodiments of the invention include a vendor id, a product sku and other information useful in tracking inventory and sales of products in table III.

TABLE III
Product Table

| | | | | | |
|---|---|---|---|---|---|
| Product | Vendor | Prod | Product | | |
| id | id | parent id | sku | Product desc | Product_image |

### Method Example II

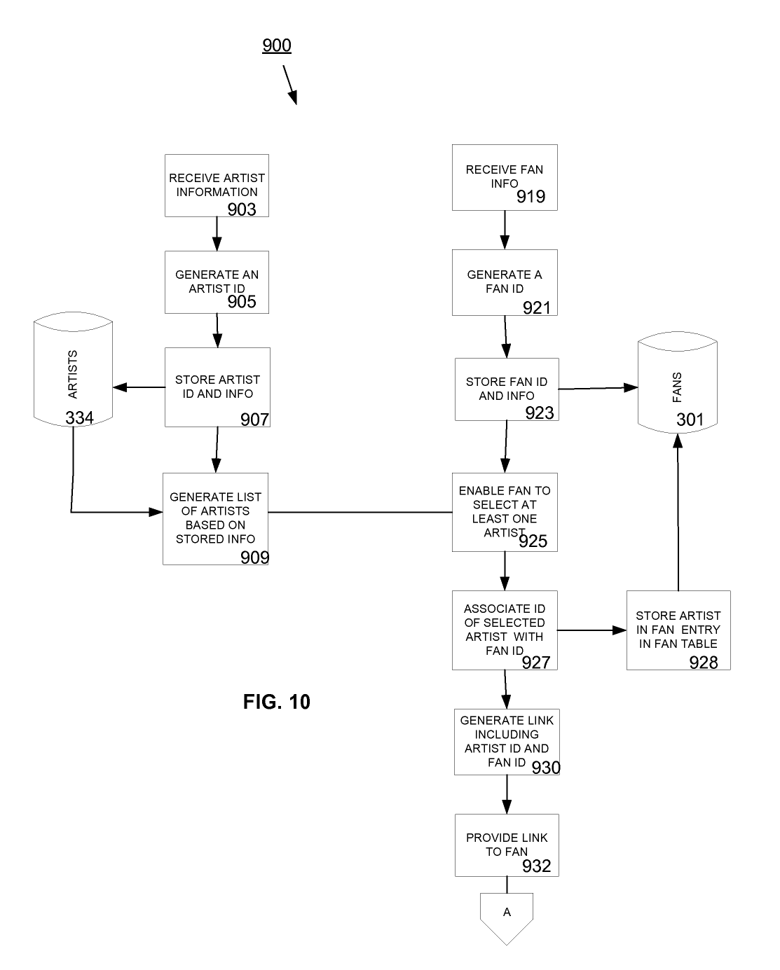

### FIG. 10

FIG. 10 illustrates a method 900 for marketing and distributing artistic works according to an embodiment of the invention. At step 903, information is provided by an artist requesting to be promoted by fans. The information is provided via a graphical user interface, for example, GUI 400 illustrated in FIG. 4. Examples of information provided by an artist and received in accordance with step 903 include at least the artist name and a title of the work to be promoted. Other information is optionally provided such as a password, email address, description of the work and price of the work.

At step 905 an artist identifier is generated in response to receiving the artist information. The artist identifier comprises a unique identifier such as a numeric, alphabetical or alphanumeric identifier. At step 907 the artist id is stored in association with the corresponding artist information. At step 909 a list of artists is generated based on the stored artist identifiers and associated artist information.

At step 919, information is received from a fan seeking to promote an artist. The information is provided by the fan via a graphical user interface, for example, GUI 500 illustrated in FIG. 5. The received information includes at least a fan name. Further optional information may be received such as the fan's email address, username, password, zip code and country.

At step 921a fan identifier is generated in response to receiving the fan information. In one embodiment of the invention the fan identifier comprises a number. Other embodiments of the invention employ alphabetical or alphanumeric identifiers. Regardless of type of identifier employed, an identifier uniquely identifies a fan. At step 923 the fan ID is stored in association with the corresponding fan information.

At step 925 a fan is enabled to select at least one artist to represent from the list of artists generated in step 909. In one embodiment of the invention the fan is enabled to select an artist by means of a graphical user interface, for example, GUI 600 illustrated in FIG. 6. At step 927, when a fan selects an artist to represent the artist ID of the selected artist is associated with the fan ID of the fan selecting the artist.

At step 930 a link to a purchase page associated with the selected artist is generated. The link includes the artist ID and the fan ID. At step 932 the link is provided to the fan. In one embodiment of the invention the link is provided to the fan by presenting the link code in a portion of a web page and presented to the fan in response to the fan selecting an artist to promote. An example of link code provided to a fan is illustrated in FIG. 7 at 704. The fan obtains the link by selecting the link code and copying the code. The copied code is then inserted by the fan into the fan's web page, email or other communication. In that manner the fan is enabled to promote the selected artist.

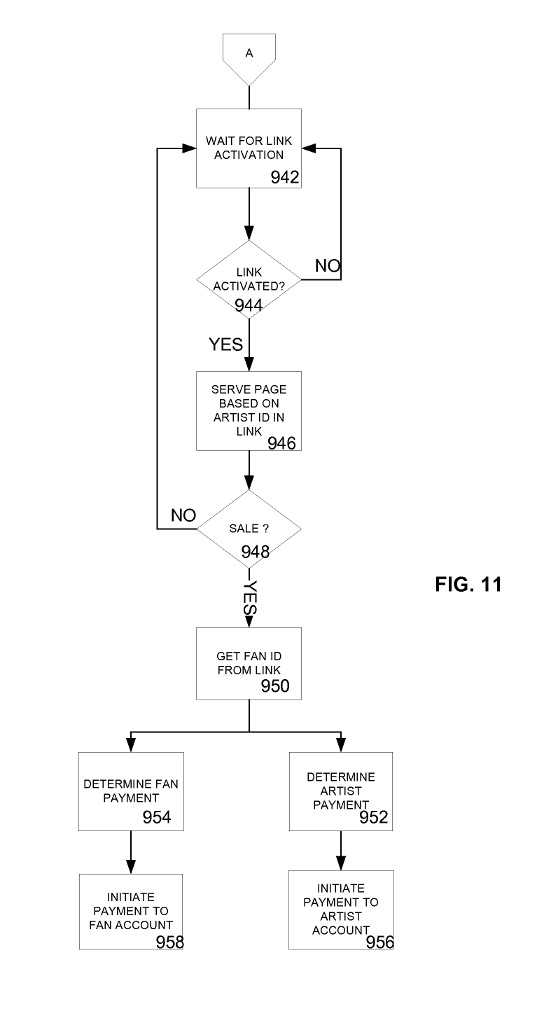

### FIG. 11

FIG. 11 illustrates further steps of a method for promoting an artist according to an embodiment of the invention. After at least one link has been provided to a fan as described above, the method waits for the link to be activated at 942. A link is activated, for example, when a third party interacts with a fan's website, email or other electronic communication, wherein the fan has embedded the link. At step 946 a web page associated with the artist included in the activated link is presented to the third party in response to the third party interaction with the fan's electronic communication.

At step 948 if the third party purchases the artist's work a fan id is obtained from the link. At step 954 a fan reward is determined. In one embodiment of the invention, a fan reward comprises a portion of the purchase price of the artist's work. In that case, at step 958, payment is initiated to the fan's account. In one embodiment of the invention, an artist payment is determined at step 952 based on the purchase price of the artist work. At step 956, payment is initiated to the artist's account. In that manner, a fan is rewarded for promoting an artist.

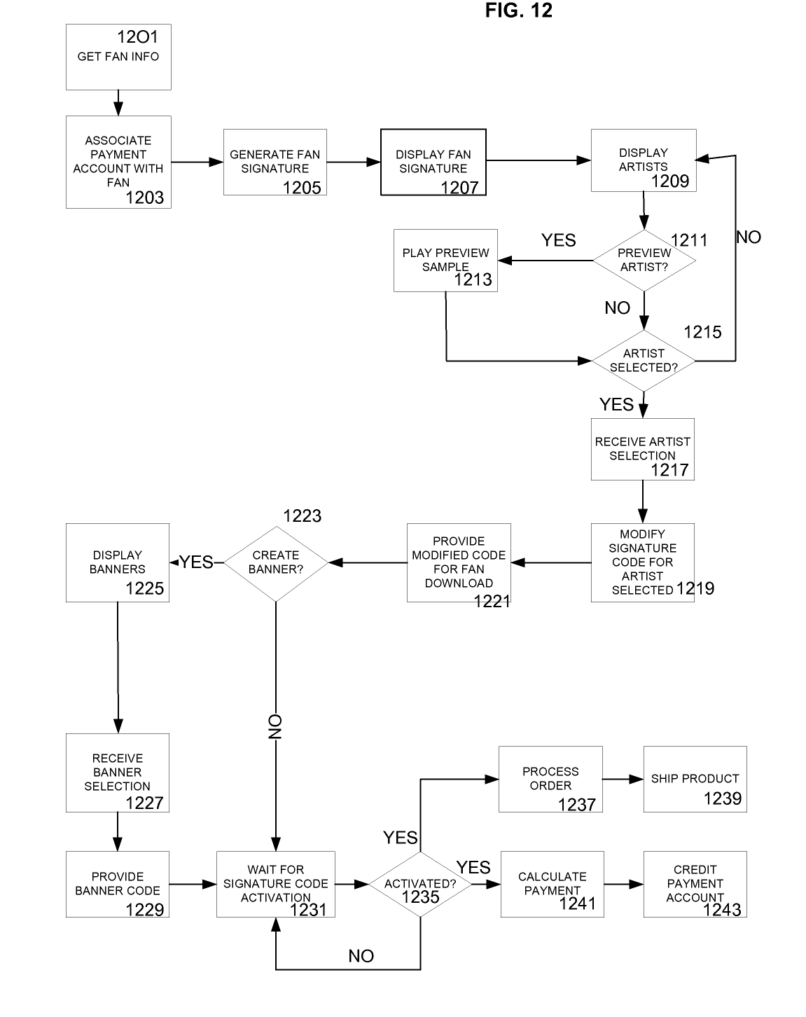

### FIG. 12

FIG. 12 illustrates steps of a method according to an embodiment of the invention. At step 1201 information is obtained from a fan. A fan wishing to represent an artist logs on to a system such as system 300 illustrated in FIG. 3. An accounting module, for example accounting module 304 of system 300, of system assigns a unique fan identifier to the fan. System 300 provides the fan with a graphical user interface. Fan information is obtained by capturing the information provided by the fan using the graphical user interface. The captured information is stored in a database. Using the graphical user interface the fan provides a payment account, for example a “Paypal” email address. At step 1203 the Paypal email address is associated with the fan id in the database.

At step 1205 a fan signature is generated and displayed to the fan at step 1207. A fan signature is an image, text or other visual representation of the fan. An example of a fan signature is illustrated in FIG. 8 at 802. At step 1209 a plurality of user-selectable icons comprising graphics, text or other images representing artists is displayed to the fan. In one embodiment of the invention, an option is presented to preview an artist's work at 1211. If the option is selected by the fan, a sample of the artist's work is played at 1213.

At step 1215 a fan selects at least one artist from the list of artists displayed at step 1209. At 1217 the artist selection is received and the fan's signature is modified to include a link to the selected. In addition the link code provided to the fan is modified to include a reference to the selected artist's artist identifier at 1221.

In one embodiment of the invention an option to create a banner is offered to the fan at 1223. If the fan elects to create a banner, a plurality of user-selectable banners is displayed to the fan at 1225. When the fan selects a banner the banner selection is received at 1227. In response to receiving the banner selection code for generating the banner is displayed to the fan at 1229. The fan is thus enabled to copy and paste the banner code into the fan's own website, email or other electronic communication. In that manner the fan promotes the artist's work by displaying the banner and the fan's signature to third parties. When a third party selects the banner or signature, the code is activated.

Step 1231 is a wait step for a third party to activate a fan's banner or signature. When the banner or signature is activated an artist's product page is displayed. The product page includes links enabling the viewer to purchase the artist's product. When the purchase link is activated, the order is processed at step 1237. Finally, the product is shipped to the third party at step 1239 in response to processing the order.

In one embodiment of the invention the fan whose link was activated resulting in the purchase receives a portion of the purchase payment as a commission. In that case, at step 1241 an amount to be paid to the fan is calculated. At step 1243 payment of the calculated amount is initiated to the payment account associated with the fan.

While the invention has been shown and described with respect to particular embodiments, it is not thus limited. Numerous modifications, changes and enhancements will now be apparent to the reader.

I claim:

1. A method for promoting artistic works comprising steps of:
storing a first identifier uniquely identifying a work to be promoted;
storing a second identifier uniquely identifying a fan to promote the work;
generating a link to a graphical user interface enabling a buyer to purchase the work, the link comprising said first and second identifiers;
providing the link to the fan;
in response to the buyer activating the link and purchasing the work, initiating payment of at least a portion of the purchase revenue to the fan identified by the second identifier.

2. The method of claim 1 wherein the step of storing a first identifier is carried out by steps of:
receiving information related to a plurality of works to be promoted;
storing corresponding first identifiers uniquely identifying each of said works to be promoted.

3. The method of claim 2 wherein the step of generating a link is carried out by steps of:
providing a list comprising at least one of the plurality of works to the fan;
enabling the fan to select a plurality of works from the list;
generating a link comprising the second identifier and first identifiers corresponding to the plurality of selected works.

4. The method of claim 1 further comprising a step of:
generating an image comprising a signature for the identified fan;
associating the link with the image.

5. The method of claim 4 wherein the step of generating an image includes steps of:
providing text identifying works selected by the fan to be promoted;
associating links to graphical user interfaces with the text identifying works selected by the fan to be promoted.

6. A system for promoting artistic works comprising:
an artist management unit including an input for receiving information about works to be promoted, the unit providing a first identifiers uniquely identifying teach work to be promoted;
a fan management unit including an input for receiving information about a fan comprising a request to promote a work, the fan management unit providing a second identifier uniquely identifying the fan;
a link generator coupled to the artist management unit and responsive to the request from the fan to generate a link to a work purchase page, the link comprising said second identifier and at least one first identifier;
a content management unit coupled to the link generator and configured to provide the link to the fan;
a purchase unit responsive to a buyer activating the link the purchase unit initiating payment of at least a portion of the purchase revenue to the fan associated with the second identifier.

7. A method for promoting artistic works comprising steps of:
providing a graphical user interface enabling an artist to provide information related to at least one artistic work to be promoted;
compiling a list of artists providing said information;
providing a graphical user interface displaying said list to a promoter and enabling said promoter to select at least one artist from said list;
in response to the selection providing said promoter with a promotion for said artist comprising a link identifying said promoter and said artist,
receiving an indication of purchase of an artistic work of said artist via activation of said link;
determining the artist and the promoter associated with said purchase based on information in the activated link;
crediting an account of said associated promoter based on said purchase.

8. The method of claim 1 further comprising steps of crediting an account of the artist based on the purchase.

9. The method of claim 1 further including a step of providing a viewer with a sample of the artistic work in response to a viewer request for the sample.

10. A system for promoting artistic works comprising:
an artist management module comprising:
a graphical user interface enabling an artist to provide artist information including information identifying at least one work of said artist to be offered for sale;
a memory coupled to the graphical user interface and configured to store said artist information including information identifying at least one work of said artist;
a sales tracking module configured to track sales of said at least one work of said artist;
a promoter management module comprising:
a graphical user interface enabling a promoter to provide promoter information and enabling said promoter to select at least one artist to promote from said stored artist information;
a link generator configured to provide a link comprising a promotion for said selected artist, the promotion including said artist identifier and a promoter identifier;
said sales tracking module configured to detect activation of said link upon purchase of said artistic work by a buyer, said sales tracking module allocating a portion of sale proceeds for said identified artist and a portion of sale proceeds to said identified promoter.
